(19) United States
(12) Patent Application Publication
(10) Pub. No.: US 2021/0370463 A1
(43) Pub. Date: Dec. 2, 2021

(54) DRIVING STRUCTURE FOR UPWARD-OPENING ABRASIVE CLOTH ROLLERS

(71) Applicant: MINCHUEN ELECTRICAL MACHINERY CO., LTD, Taichung City (TW)

(72) Inventor: TA CHUANG WEI, TAICHUNG CITY (TW)

(21) Appl. No.: 16/885,217

(22) Filed: May 27, 2020

(51) Int. Cl. B24B 47/12; F16H 1/28

(52) U.S. Cl. CPC B24B 47/12; F16H 1/28

(57) ABSTRACT

A driving structure for upward-opening abrasive cloth roller mainly consists a motor mounted in the roller. The driving structure includes: a roller, a first side member, a second side member, a motor with an outer ring gear integrated into a rotating structure; and a motor, a linking shaft bearing, a connecting member, a fixed member and a second bearing integrated with the roller as a stationary structure. The power of the motor is transmitted to the linking shaft, the sun gear, the planet gear through the rotating shaft of the motor, and finally transmitted to the outer ring gear, so that the roller can be rotated.

### BACKGROUND of INVENTION

### Field of Invention

The present invention relates to a driving structure for upward-opening abrasive cloth rollers, and more particularly to a driving structure combined with the roller.

### Description of Related Art

Currently, the conventional machine structure of the abrasive cloth roller mainly comprises a roller with an abrasive cloth outside, an external motor with connection of a belt and an idler structure for transmitting power to the roller to rotate. The above structure actually has the following disadvantages:

(1) The motor, the idler, and the belt drive the roller together. However, the motor is an external structure because of requiring a large space, so the entire abrasive cloth roller machine has large dimensions.

(2) To transmit power through the belt transmission, it is required to pay attention to the belt tension and make adjustment to ensure that the belt and each transmission wheel have appropriate fit. However, the disadvantage of the belt drive is that the belt may slip during high-speed operation or need to be replaced. And, it is more likely result in breakage during operation due to negligence of inspection, which causes high elimination rate and high maintenance costs.

Therefore, it is desirable to provide a driving structure for upward-opening abrasive cloth rollers to mitigate and/or obviate the aforementioned problems.

### SUMMARY of INVENTION

An objective of present invention is to provide an adjustment structure of upward-opening abrasive cloth rollers, which is capable of improving the above-mention problems.

In order to achieve the above mentioned objective, A driving structure for upward-opening abrasive cloth roller mainly consists a motor mounted in the roller. The driving structure includes: a roller, a first side member, a second side member, a motor with an outer ring gear integrated into a rotating structure; and a motor, a linking shaft bearing, a connecting member, a fixed member and a second bearing integrated with the roller as a stationary structure. The power of the motor is transmitted to the linking shaft, the sun gear, the planet gear through the rotating shaft of the motor, and finally transmitted to the outer ring gear, so that the roller can be rotated.

Other objects, advantages, and novel features of invention will become more apparent from the following detailed description when taken in conjunction with the accompanying drawings.

### BRIEF DESCRIPTION OF DRAWINGS

FIG. 1 is a perspective drawing of a preferred embodiment according to the present invention.

FIG. 2 is a cross-sectional view of the preferred embodiment according to the present invention.

FIG. 3 is an enlarged view along line A-A shown in FIG. 2.

### DETAILED DESCRIPTION OF PREFERRED EMBODIMENT

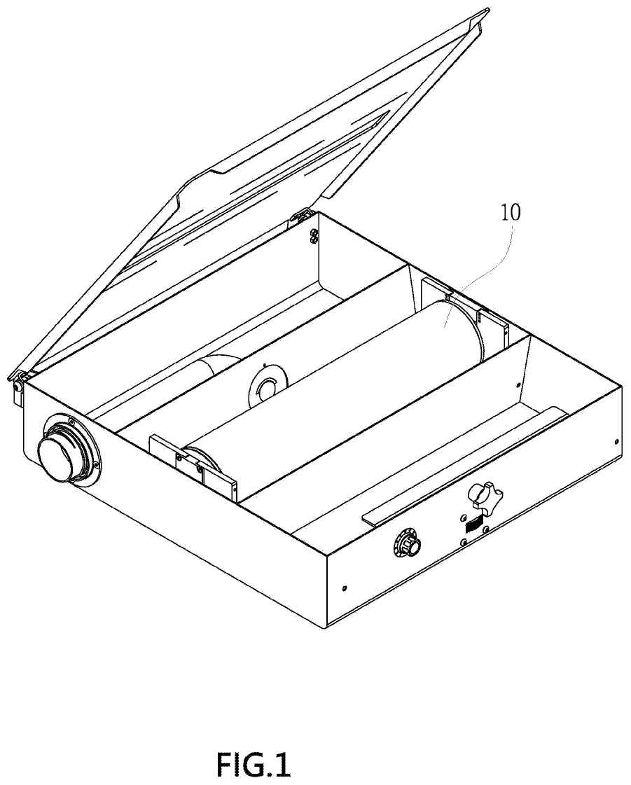

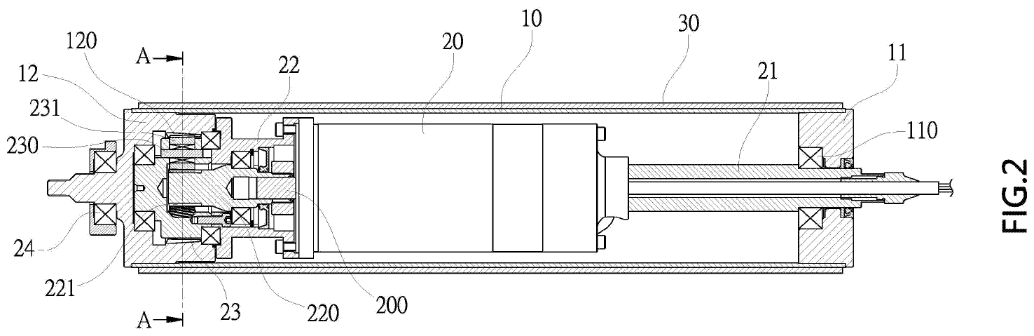

First, please refer to FIGS. 1-4. A driving structure for upward-opening abrasive cloth rollers comprises: a roller 10, a motor 20, a linking shaft 220, a passive shaft 230 and an abrasive cloth layer 30. The roller 10 respectively has a first side member 11 and a second side member 12 at each end, the first side member 11 has a first bearing 110 and the second side member 12 has an outer ring gear 120. The motor 20 is mounted in the roller 10. One end of the motor 20 is connected to a hollow first shaft 21 passing through the first bearing and accommodating a cable of the motor 20, and another end of the motor 20 is connected to a hollow connecting member 22, a fixed member 23, the second side member 12 and a second bearing 24. The linking shaft 220 passes through the connecting member 22 and is connected to a rotating shaft 200 of the motor 20, and a sun gear 221 is disposed at an end of the linking shaft 220. The passive shaft 230 passes through the fixed member 223 and engages with a planet gear 231, the sun gear 221 and the outer ring gear 120. The abrasive cloth 30 is disposed and wrapped around the roller 10, which can be replaced for different ones. When the machine is turned on, the motor 20, the first shaft 21, the connecting member 22, the fixed member 23 and the second bearing 24 compose a stationary structure, and the first, the second side members 11, 12 and the roller 10 compose a rotatable structure. The motor 20 drives the rotating shaft 200 to rotate the linking shaft 220, the sun gear 221, the planet gear 231, the outer ring gear 120 and the roller 10.

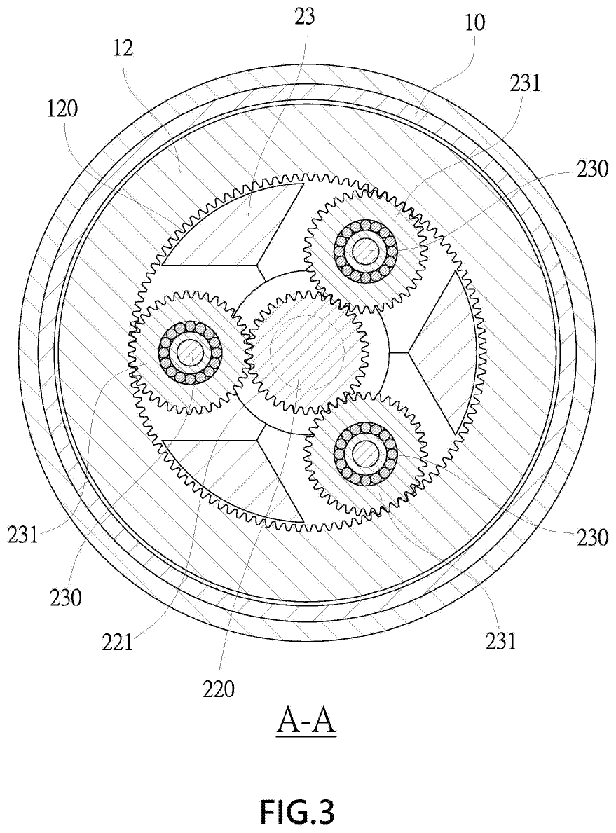

In addition, the fixed member 23 has more than one passive shaft 230 and more than one planet gear 231, as shown in FIG. 3, there are three passive shafts 230 and three planet gears 231, and all of the planet gears 231 engage with the sun gear 221 and the outer ring gear 120. Therefore, the motor is capable to transmit torque to the outer ring gear 120 without causing the gear to slip.

Furthermore, the linking shaft 220 and the sun gear 221 can be individual objects, the sun gear 221 can be an independent abject than the linking shaft 220. Also, the passive shaft 230 and the passive gear 231 can be integrally formed, the second side member 12 and the outer ring gear 120 are individual objects, and the outer ring gear 120 may be an independent object mounted on the second side member 12.

According to the above structure, the following functions and advantages can be obtained:

(1) The motor 20 and the entire transmission structure are hidden inside the roller 10, which can greatly reduce the volume of the machine.

(2) By utilizing planetary gear system, the transmission efficiency is higher, the service life is longer, the weariness is less, and the maintenance cost is lower.

Although the present invention has been explained in relation to its preferred embodiment, it is to be understood that many other possible modifications and variations can be made without departing from the spirit and scope of invention as hereinafter claimed.

What is claimed is:

1. A driving structure for upward-opening abrasive cloth rollers comprising:
a hollow roller respectively having a first side member and a second side member at each end, the first side member having a first hollow bearing and the second side member having an outer ring gear;
a motor mounted in the roller, one end of the motor connected to a hollow first shaft passing through the first bearing and accommodating a cable of the motor and another end of the motor connected to a hollow connecting member, a fixed member, the second side member and a second bearing;
a linking shaft passing through the connecting member and connected to a rotating shaft of the motor, and a sun gear disposed at an end of the linking shaft;
a passive shaft passing through the fixed member and engaging with a planet gear, the sun gear and the outer ring gear; and
an abrasive cloth layer disposed around the roller.

2. The driving structure for upward-opening abrasive cloth rollers as claimed in claim 1, wherein the fixed member has more than one passive shaft and more than one planet gear, and all of the planet gears engage with the sun gear and the outer ring gear.

3. The driving structure for upward-opening abrasive cloth rollers as claimed in claim 1, wherein the abrasive cloth layer is wrapped around the roller and is removable.

4. The driving structure for upward-opening abrasive cloth rollers as claimed in claim 1, wherein the linking shaft and the sun gear are detachable, and the sun gear is an independent gear mounted on the linking shaft.

5. The driving structure for upward-opening abrasive cloth rollers as claimed in claim 1, wherein the passive shaft and the planet gear are integrated together.

6. The driving structure of upward-opening abrasive cloth rollers as claimed in claim 1, wherein the second side member and the outer ring gear are detachable, and the outer ring gear is an independent gear mounted on the second side member.
